(19) United States
(12) Patent Application Publication
(10) Pub. No.: US 2026/0086788 A1
(43) Pub. Date: Mar. 26, 2026

(54) METHOD FOR DEPLOYMENT VALIDATION OF AN APPLICATION CONTAINER IMAGE ONTO RESOURCE-CONSTRAINED TARGET DEVICES

(71) Applicant: Atym, Inc., San Francisco, CA (US)

(72) Inventors: Stephen Roland BERARD, Rasteau (FR); Jason Alan SHEPHERD, Austin, TX (US)

(21) Appl. No.: 19/340,029

(22) Filed: Sep. 25, 2025

Related U.S. Application Data
(60) Provisional application No. 63/698,850, filed on Sep. 25, 2024.

(51) Int. Cl. G06F 8/61

(52) U.S. Cl. CPC G06F 8/63

(57) ABSTRACT

A method includes: receiving a request to deploy a container image onto a set of devices; accessing a set of parameters defining constraints for deployment of the container image; accessing a set of attributes of a target device in the set of devices; in response to the set of attributes falling outside of the set of parameters, classifying the device into a subset of devices on which the container image is unable to deploy; deriving a set of actions for remediating the target device; calculating a set of projected attributes of the target device based on the set of actions; in response to the set of projected attributes falling within the set of parameters, identifying the set of actions as a candidate remediation for the target device; generating a visualization indicating subset of devices—including the target device—and the candidate remediation; and serving the visualization to a user.

### CROSS-REFERENCE TO RELATED APPLICATIONS

This Application claims the benefit of U.S. Provisional Application No. 63/698,850, filed on 25 Sep. 2024, which is incorporated in its entirety by this reference.

### TECHNICAL FIELD

This invention relates generally to the field of software application containerization and, more specifically, to a new and useful method for deployment validation of an application container image onto resource-constrained target devices within the field of software application containerization.

### BRIEF DESCRIPTION OF THE FIGURES

FIG. 1 is a flowchart representation of a method;

FIGS. 2A and 2B are flowchart representations of one variation of the method; and

FIG. 3 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Methods

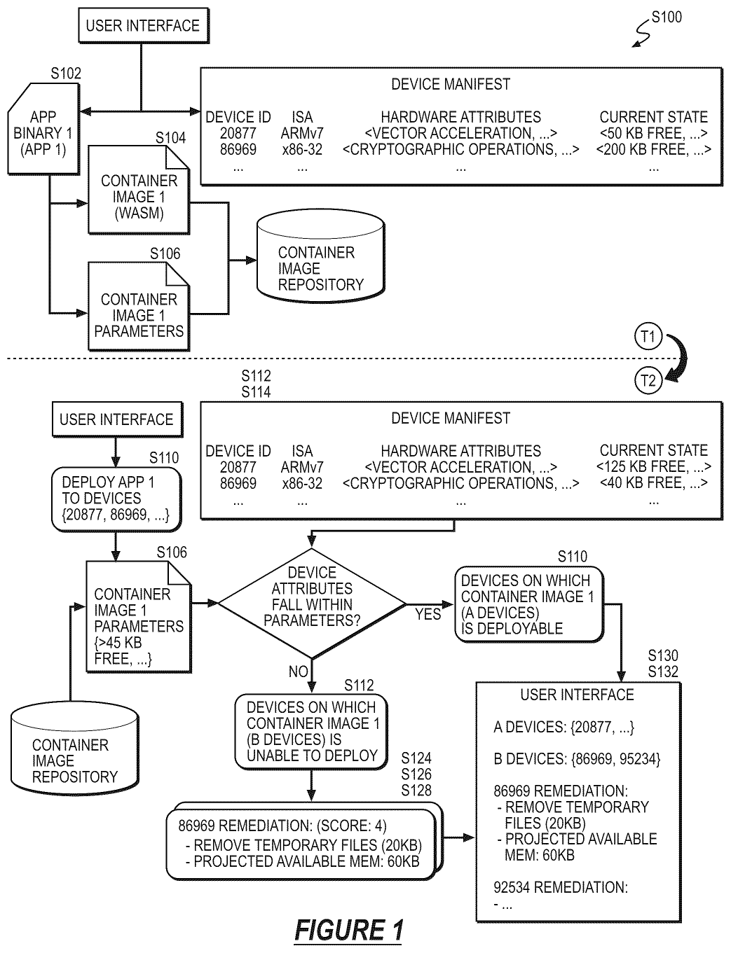

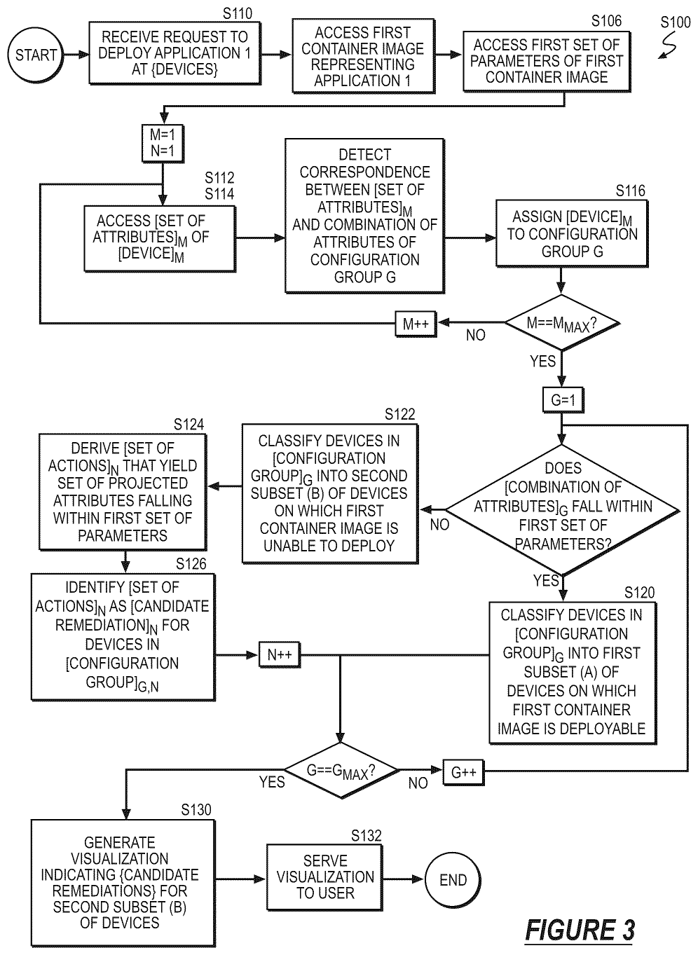

As shown in FIGS. 1, 2A, and 3, a method S100 includes: receiving a request to deploy a container image onto a set of devices including a first device and a second device in Block SS110; accessing a set of parameters defining constraints for deployment of the container image in Block S106; accessing a first set of attributes of the first device in Block S112; and accessing a second set of attributes of the second device in Block S114. The container image includes: an application binary representing an application; and a set of dependencies for executing the application binary.

The method S100 also includes: in response to detection of the first set of attributes falling within the set of parameters, classifying the first device into a first subset of devices on which the container image is deployable in Block S120; in response to detection of the second set of attributes falling outside of the set of parameters, classifying the second device into a second subset of devices on which the container image is unable to deploy in Block S122; deriving a first set of actions that, when executed at the second device, yield a first set of projected attributes falling within the set of parameters in Block S124; and identifying the first set of actions as a first candidate remediation for the second device in Block S126.

The method S100 further includes: generating a visualization in Block S130; and serving the visualization to a user in Block S132. The visualization indicates: the second subset of devices, including the second device; and the first candidate remediation, including the first set of actions.

### 1.1 Variation: Container Image Remediation

As shown in FIGS. 1, 2A, and 3, one variation of the method S100 includes: accessing a first application binary representing an application in Block S102; generating a first container image including the first application binary and a set of dependencies for executing the first application binary in Block S104; and accessing a first set of parameters defining constraints for deployment of the first container image in Block S106.

This variation of the method S100 also includes: receiving a request to deploy the first container image onto a set of devices including a first device in Block S110; accessing a first set of attributes of the first device in Block S112; in response to the first set of attributes falling outside of the first set of parameters, classifying the first device into a subset of devices on which the first container image is unable to deploy in Block S122; based on the first container image and the first set of attributes, deriving a set of actions that yield a second set of parameters of a second container image, representing the application, for deployment onto the first device in Block S124; in response to the first set of attributes falling within the second set of parameters, identifying the set of actions as a candidate remediation for the first device in Block S126; generating a visualization in Block S130; and serving the visualization to a user in Block S132. The visualization indicates: the subset of devices including the first device; and the candidate remediation, including the set of actions.

### 1.2 Variation: Configuration Group

As shown in FIGS. 1, 2A, and 3, one variation of the method S100 includes: receiving a request to deploy a container image onto a set of embedded devices including a first embedded device in Block S110; accessing a set of parameters defining constraints for deployment of the container image in Block S106; and accessing a first set of attributes of the first device in Block S112. The container image includes: an application binary representing an application; and a set of dependencies for executing the application binary. The first set of attributes represents a first configuration of the first embedded device.

This variation of the method S100 also includes: in response to correspondence between the first set of attributes and a first combination of attributes for a first configuration group, assigning the first embedded device to the first configuration group in Block S116; in response to the first combination of attributes falling outside of the set of parameters, classifying devices in the first configuration group into a subset of embedded devices on which the container image is unable to deploy in Block S122; deriving a set of actions that, when executed at the first embedded device, yield a set of projected attributes falling within the set of parameters in Block S124; and identifying the set of actions as a candidate remediation for embedded devices in the first configuration group in Block S126.

### 2. Applications

Generally, a system including a remote computer system (e.g., a remote server) can execute Blocks of the method S100: to receive a target application compiled according to an instruction set architecture (e.g., “WebAssembly”); to package the target application into an immutable application container image (hereinafter “container image”) including components for executing the target application in a container runtime environment on a target device (e.g., an embedded device, an IoT device, a camera, a sensor, a personal computer, a server, a smartphone); to derive parameters—representing constraints (e.g., hardware constraints, software constraints, performance criteria) for executing the container image at the target device—based on the target application and/or the components; to store this container image and the parameters in a container image repository; to register a set of diverse devices characterized by different instruction set architectures (e.g., “x86-32,” “ARMv7,” “MIPS64,” “SPARC-V9”) and different hardware configurations; and to monitor a configuration and a state of each device.

Then, in response to a request to deploy the target application onto a first device, the system can execute Blocks of the method S100: to retrieve the parameters of the container image associated with the target application from the container image repository; to retrieve a first configuration and/or a (current) first state of the first device; and to classify the first device into a first subset of devices—onto which the container image is deployable—in response to detection of the first configuration and the first state of the first device falling within the parameters of the container image.

Alternatively, the system can execute Blocks of the method S100 to classify the first device into a second subset of devices—onto which the container image is unable to deploy—in response to detection of the first configuration and the first state of the first device falling outside of the parameters of the container image.

Therefore, rather than deploying the container image onto a device that is unable to support execution of the container image, the system can execute Blocks of method S100 to validate that the container image is deployable and/or executable on the device—prior to transmission of the container image to this device—in order to avoid (or reduce) resource waste from a failed deployment attempt, such as: communication overhead for transmitting the container image to the device on which the container image will fail to deploy; and/or resource overhead for remediating (or “rolling back”) the device on which deployment of the container image has failed.

Additionally, in response to the request indicating deployment of the target application onto other devices, the system can repeat Blocks of the method S100 for each of these devices: to retrieve a configuration and a (current) state of the device; and to classify the device into the first subset of devices—or the second subset of devices—based on the configuration and the state of the first device relative to the parameters of the container image. The system can then execute Blocks of the method S100: to generate a visualization indicating the first subset of devices—onto which the container image is deployable—and/or the second subset of devices onto which the container image is unable to deploy; and to serve the visualization to a user (e.g., a system administrator).

Accordingly, the system can execute Blocks of the method S100: to receive a request to deploy the container image to a target set of (e.g., 100,000) devices; to identify a subset of (e.g., 10,000) devices on which the container image is unable to deploy; and to notify the user of this subset of devices prior to transmission of the container image. Therefore, the system can execute Blocks of the method S100: to enable the user to alter a deployment plan of the container image for the subset of devices; and/or to expose additional insights—such as deficiencies of this subset of devices—to the user in order to enable the user to remediate these deficiencies at increased speed and reduced cost.

### 2.1 Configuration Groups & Remediation

Additionally, for each device identified as unable to support deployment of the container image, the system can execute Blocks of the method S100: to identify a set of actions that remediate (or modify) the device and/or the container image to enable deployment of the container image onto the device; to validate that the set of actions yield a configuration and a state of the device that falls within the parameters of the container image; and to augment the visualization with the set of actions that remediate this device for analysis and/or confirmation by the user.

More specifically, the system can execute Blocks of the method S100: to group devices exhibiting identical configurations (and/or identical states) into a configuration group; to detect a potential deployment failure of the container image for devices in the configuration group; to derive a set of actions that enable deployment of the container image onto the devices in the configuration group; to validate the set of actions for a representative device in the configuration group; in response to successful validation of the set of actions for the representative device, to designate the set of actions as a candidate remediation for all devices in the configuration group; and to expose the candidate remediation to the user for analysis and/or confirmation.

Therefore, rather than separately deriving and validating remediation actions for each device on a per-device basis, the system can: identify a configuration that is shared (or common) across a group of devices; derive a set of actions—specific to this configuration—that resolve the potential deployment failure of the container image to this group of devices; and validate the set of actions for a representative device in the group of devices, thereby enabling one instance of derivation, validation, and execution of the set of actions to scale across many (e.g., 100, 1000) devices exhibiting this configuration.

### 2.2 Variation: Other Device Types

As described herein, the system executes Blocks of the method S100: to receive a request to deploy a container image to a target embedded device; and to validate that the container image is deployable onto the target embedded device based on a configuration and a state of the target embedded device relative to parameters of the container image.

However, the system can similarly execute Blocks of the method S100: to receive a request to deploy the container image to a target device of another type (e.g., a general purpose computer, a laptop computer, a tablet, a smartphone); to retrieve a configuration and a (current) state of the target device; to classify the target device into a first subset of devices onto which the container image is deployable—or a second subset of devices on which the container image is unable to deploy—based on the configuration and the state of the target device relative to the parameters of the container image: to generate a visualization indicating the first subset of devices and the second subset of devices; and to serve the visualization to a user.

### 3. Terminology

Generally, an “application binary” is referred to herein as compiled, executable instructions (or “machine code”) representing an application and specific to an instruction set architecture, such as a physical instruction set architecture (e.g., “ARMv7,” “x86-32”) or a bytecode instruction set architecture (e.g., “WebAssembly,” “JAVA Virtual Machine Instruction Set”).

Generally, a “container image” is referred to herein as an immutable, executable file including an application binary and any additional dependencies for executing the application binary.

### 4. System

Generally, the system can include or interface with: a user device (e.g., a desktop computer, a laptop computer, a tablet, a smartphone) accessed by a user such as an application developer or a system administrator; a remote computer system (e.g., a remote server); and a set of target devices (e.g., embedded devices, edge devices, IoT devices, cameras, sensors, servers, smartphones).

In one implementation, the remote computer system receives a target application from the user device (e.g., via a user interface).

More specifically, the remote computer system can receive an application binary including a set of executable instructions representing the target application.

In this implementation, the remote computer system: generates a container image (or a “containerized application”) representing the target application; and stores the container image in a container image repository. For example, the remote computer system can generate the container image including: the application binary; a set of dependencies (e.g., libraries, other binaries); a set of configuration files; a set of metadata; etc.

Additionally, the remote computer system can: derive a set of parameters representing constraints (e.g., hardware constraints, software constraints, performance criteria) for deployment and/or execution of the container image; and store the set of parameters associated with the container image in the container image repository. For example, the remote computer system can derive the set of parameters based on the application binary and/or the set of dependencies, etc.

In another implementation, the remote computer system receives a request (e.g., via the user interface) to deploy the container image onto the set of target devices. For each target device in the set of target devices, the remote computer system: accesses a set of attributes representing a configuration and a current state of the target device; and classifies the target device based on the set of attributes and the set of parameters.

In one example, the remote computer system classifies the target device in a first subset of target devices—on which the container image is deployable—in response to detecting the set of attributes of the target device falling within the set of parameters of the container image.

In another example, the remote computer system classifies the target device in a second subset of target devices—on which the container image is unable to deploy and/or execute—in response to the set of attributes of the target device falling outside of the set of parameters of the container image.

In this implementation, the remote computer system: generates a visualization indicating the first subset of target devices and the second subset of target devices; and serves the visualization to a user (e.g., via the user interface).

Accordingly, the remote computer system can validate that the container image is deployable and/or executable on target devices prior to transmission of the container image to these target devices in order to reduce instances of failed deployment. Therefore, the computer system can: enable a user to alter a deployment plan in response to detecting instances of (potential) failed deployment; and avoid (or reduce) resource waste associated with these instances of failed deployment, such as communication overhead for transmitting the container image to target devices on which the container image will fail to deploy and/or resource overhead for remediating a target device on which deployment of the container image has failed.

### 4.1 Target Devices

In one implementation, a target device (e.g., an embedded device, a resource-constrained device) includes a set of resources, such as: a processor (e.g., a central processing unit, a microcontroller); a graphics processing unit; memory; storage; an internal communication bus; a network interface; etc.

### 4.2 Container Runtime Module

Generally, the device can include a container runtime module for executing a container image. More specifically, the container runtime can include a container runtime environment and a hardware abstraction layer.

In one implementation, the container runtime module includes an operating system (e.g., a real-time operating system, a LINUX operating system, an ANDROID operating system) and/or a set of container functions (e.g., data extraction functions, data processing functions, machine learning functions) for executing a container image.

In this implementation, the container runtime module maps the set of container functions to the set of resources of the device via the hardware abstraction layer.

### 5. Container Image

The method S100 includes: accessing an application binary representing an application in Block S102; generating a container image including the application binary and a set of dependencies for executing the application binary in Block S104; and accessing a set of parameters defining constraints for deployment of the container image in Block S106.

Generally, in Blocks S102, S104, and S106, the remote computer system can: receive an application binary representing a target application for execution at a set of target devices; generate a container image including the application binary; and store the container image in a container image repository.

In one implementation, the user device: accesses a target application (e.g., a first application) including a set of operations; and compiles the target application into an application binary according to an instruction set architecture (e.g., “WebAssembly”). The initial application binary includes a set of instructions (e.g., bytecode, machine code) representing the set of operations and characterized by the instruction set architecture.

In this implementation, the user device transmits (e.g., uploads) the application binary to the remote computer system.

In another implementation, in Block S102, the remote computer system receives the application binary from the user device (e.g., via a user interface executing on the user device, via an application programming interface).

In response to receiving the application binary, the remote computer system generates a container image including the application binary in Block S104. For example, the container image can include: the application binary; a set of dependencies (e.g., libraries, other binaries) for executing the application binary; a set of configuration files; and/or a set of metadata; etc.

In this implementation, the remote computer system stores the container image—characterized by the instruction set architecture—in the container image repository.

For example, the remote computer system can store the container image characterized by a container identifier (e.g., a hash of the container image).

Additionally or alternatively, the remote computer system can store the container image associated with an application identifier of the target application represented by the application binary in the container image.

Therefore, the system can abstract architecture and orchestration of diverse target devices in order to simplify application development for a user (e.g., an application developer) to develop, test, and/or deploy an application on these diverse target devices.

### 5.1 Container Image Parameters

Block S106 recites accessing a first set of parameters defining constraints for deployment of the first container image.

Generally, in Block S106, the remote computer system can access (or derive) a set of parameters defining constraints for deployment and/or execution of the container image.

In one implementation, the remote computer system executes the foregoing methods and techniques to generate the container image, including: the application binary; the set of dependencies; the set of configuration files; and/or the set of metadata; etc.

In this implementation, in Block S106, the remote computer system derives the set of parameters based on: the application binary, the set of dependencies, the set of configuration files, and/or the set of metadata, etc.

In one example, the remote computer system: scans the application binary; detects the set of dependencies, a set of imports (e.g., data, functions, resources), and/or a set of exports (e.g., data, functions, resources) based on the application binary; and derives the set of parameters representing the set of dependencies, the set of imports, and/or the set of exports.

In another example, the remote computer system: detects a set of resource constraints—such as a threshold amount of available memory, a threshold amount of available network bandwidth, a (required) type of hardware resource (e.g., a neural network accelerator, a pressure sensor, a BLUETOOTH network radio) for the target application, etc.—for executing the application binary based on the set of metadata; and derives the set of parameters representing the set of resource constraints.

In another example, the remote computer system: detects a set of additional constraints—such as a certificate (e.g., an authorization certificate, a public key certificate) or other permissions—for executing the application binary based on the set of metadata; and derives the set of parameters representing the set of additional constraints.

Additionally or alternatively, the remote computer system can: access a set of performance criteria for executing the application (and/or the container image); and derive the set of parameters representing the set of performance criteria.

For example, the system can access the set of performance criteria representing time-criticality constraints of the application. More specifically, the set of performance criteria can include: a task execution time threshold (e.g., two milliseconds) and degree of determinism; a jitter value threshold (e.g., 50 microseconds); etc.

In this example, the system can derive the set of parameters representing the task execution time threshold and the jitter value, thereby enabling the system to conform to the time-criticality constraints of the application.

In this implementation, the remote computer system stores the set of parameters associated with the container image in the container image repository (and/or a second data repository).

Therefore, by deriving the set of parameters for executing the container image, the remote computer system can detect—a priori—that the container image is deployable (or unable to deploy) onto a target device based on set of parameters and a set of attributes of the target device.

### 6. Device Attributes

The method S100 includes: accessing a first set of attributes of the first device in Block S112; and accessing a second set of attributes of the second device in Block S114.

Generally, in Blocks S112 and S114, the remote computer system can characterize attributes representing a configuration and a current state of a target device during a target time interval.

In one implementation, in Block S112, the remote computer system accesses (or detects) a first set of attributes representing a first target device in the set of target devices. The first set of attributes represent: a first configuration (e.g., a hardware configuration, a software configuration) of the first target device; and/or a first state (e.g., current available memory, current processor utilization, current power level) of the first target device during a first time interval. The remote computer system stores the first set of attributes associated with the first target device in a data repository (e.g., a database).

In one example, the remote computer system can detect the first set of attributes representing: an instruction set architecture of the first target device; a processor type (e.g., a central processing unit, a microcontroller, word size, a quantity of cores) of the first target device; an application binary interface of the first target device; an application binary interface (e.g., an embedded application binary interface) format (e.g., hardware floating-point (or “hard-float”) application binary interface for ARM targets, double-precision hardware floating-point application binary interface, single-precision hardware floating-point application binary interface, software floating-point (or “soft-float”) application binary interface) of the first target device; a memory capacity (e.g., kilobytes of memory capacity) of the first target device; a memory type (e.g., EEPROM, flash memory, SRAM, DRAM, DDRSRAM, GPIO external memory) of the first target device; a storage capacity (e.g., megabytes of storage, gigabytes of storage) of the first target device; a storage type (e.g., flash storage, hard disk storage) of the first target devices; a peripheral bus type (e.g., I2C, MODBUS, CAN bus); a sensor type (e.g., a pressure sensor, an accelerometer, a temperature sensor) associated with the first target device; a hardware accelerator type of the first target device; a network interface (e.g., Ethernet, WiFi, LoraWAN, cellular) of the first target device; and/or other peripherals of the first target device.

In another example, the remote computer system detects the first set of attributes representing: a first container runtime module in the first target device; a set of container images deployed onto the first target device; and/or other dependencies or data stored on the first target device.

In another example, the remote computer system: receives (e.g., from a first agent executing at the first target device) a first set of state information representing the first state of the first target device during the first time interval (e.g., at a first time during the first time interval); and detects the first set of attributes based on the first state.

More specifically, the first agent can generate the first set of state information representing: processor (e.g., central processing unit, microcontroller, graphics processing unit) utilization(s); available processor capacity (e.g., processor cycles); memory utilization; available memory capacity; network utilization; available network bandwidth; storage utilization; available storage capacity; power utilization; available power capacity; and/or a set of processes executing on the first target device; etc. The first agent can transmit the first set of state information to the remote computer system.

In this example, the system can repeat the foregoing methods and techniques for each time interval in a set of time intervals: to generate a set of state information representing a state of the first target device during the time interval; to define a set of attributes representing the first target device for the time interval based on the state; and to store the set of attributes associated with the first target device in the data repository.

The remote computer system can repeat the foregoing methods and techniques for each target device in the set of target devices: to detect a set of attributes representing a configuration and a state of the target device; and to store the set of attributes associated with the target device in the data repository.

Therefore, the remote computer system can fully characterize configurations and real-time states of a heterogeneous fleet of devices in order to validate deployment capability of a container image onto target devices based on these configurations and states.

### 7. Deployment Validation

The method S100 includes: receiving a request to deploy a container image onto a set of devices in Block S110; and accessing a set of parameters defining constraints for deployment of the container image in Block S106. The set of devices includes a first device and a second device.

The method S100 includes: accessing a first set of attributes of the first device in Block S112; and accessing a second set of attributes of the second device in Block S114.

The method S100 includes: in response to the first set of attributes falling within the set of parameters, classifying the first device into a first subset of devices on which the container image is deployable in Block S120; and, in response to the second set of attributes falling outside of the set of parameters, classifying the second device into a second subset of devices on which the container image is unable to deploy in Block S122.

The method S100 includes: generating a visualization indicating the second subset of devices, including the second device in Block S130; and serving the visualization to a user in Block S132.

Generally, in Blocks S106, S110, S112, S114, S120, S122, S130, and S132, the remote computer system can: receive a request (e.g., via a user interface, via an application programming interface) to deploy a container image onto a set of target devices; and access the set of parameters of the container image. For each target device in the set of target devices, the computer system can: access a set of attributes representing the target device; and classify the target device into a subset of target devices in the set of target devices based on the set of parameters and the set of attributes. For example, in response to the set of attributes of the target device falling within the set of parameters of the container image, the remote computer system can classify the target device into a first subset of target devices on which the application container is deployable. Alternatively, in response to the set of attributes of the target device falling outside of the set of parameters of the container image, the remote computer system can classify the target device into a second subset of target devices on which the application container is unable to deploy. The remote computer system can: generate a visualization indicating the first subset of target devices and/or the second subset of target devices; and serve the visualization to a user (e.g., via the user interface, via the application programming interface) responsive to the request.

Therefore, by detecting that the container image is unable to deploy onto a target device prior to transmission of the container image onto the target device, the remote computer system can avoid (or reduce) resource overhead for transmitting the container image to the target device (or remediating) on which the container image will fail to deploy and/or execute.

### 7.1 Request

In one implementation, in Block S110, the remote computer system receives a request (e.g., via the user interface) to deploy a container image—representing an application—onto a set of target devices, such as a first target device (e.g., a first embedded device) and a second target device (e.g., a second embedded device).

For example, the remote computer system can receive the request indicating: an application identifier associated with the application; and a set of device identifiers associated with the set of target devices.

Additionally or alternatively, the remote computer system can receive the request indicating a container identifier of the container image.

### 7.2 Validation

In one implementation, in Block S106, the remote computer system accesses the set of parameters defining constraints for deployment of the container image.

In another implementation, the system executes the foregoing methods and techniques to access a first set of attributes—of the first target device—representing a first configuration and a first state of the first target device.

In this implementation, the system detects whether the first set of attributes of the first target device fall within the set of parameters of the container image.

More specifically, for each parameter in the set of parameters, the system can: access a subset of attributes, in the first set of attributes, associated with the parameter; and detect that the subset of attributes falls within (or falls outside of) the parameter.

In one example, the remote computer system: accesses a first parameter, in the set of parameters, representing a threshold (e.g., minimum) amount of available memory (e.g., 50 kilobytes); accesses a first attribute, in the first set of attributes, representing a first amount of available memory (e.g., 180 kilobytes) in the first target device; and detects that the first attribute of the first target device falls within the first parameter of the container image (e.g., the first amount of available memory in the first target device exceeds the threshold amount of available memory for the container image).

In another example, the remote computer system: accesses a second parameter, in the set of parameters, representing presence of a pressure sensor for functionality of the application; accesses a second attribute, in the first set of attributes, representing presence of a first pressure sensor in the first target device; and detects that the second attribute of the first target device falls within the second parameter of the container image (e.g., detecting presence of the pressure sensor in the first target device).

In response to detecting the first set of attributes of the first target device falling within the set of parameters of the container image, the remote computer system classifies the first target device in a first subset of target devices on which the application container is deployable in Block S120.

In another implementation, the system executes the foregoing methods and techniques to: access a second set of attributes—of the second target device—representing a second configuration and a second state of the second target device; and detect whether the second set of attributes of the second target device falls within the set of parameters of the container image.

For example, the remote computer system can: access the first parameter representing the threshold amount of available memory (e.g., 50 kilobytes); access a third attribute, in the second set of attributes, representing a second amount of available memory (e.g., 45 kilobytes) in the second target device; and detect that the third attribute of the second target device falls outside of the first parameter of the container image (e.g., the second amount of available memory in the first target device falls below the threshold amount of available memory for the container image).

In response to detecting the second set of attributes of the second target device falling outside of the set of parameters of the container image, the remote computer system classifies the second target device in a second subset of target devices on which the application container is unable to deploy in Block S122.

The remote computer system can repeat the foregoing methods and techniques for each target device in the set of target devices: to access a set of attributes of the target device; and to classify the target device into a subset of target devices based on the set of attributes of the target device and the set of parameters associated with the container image.

For example, the remote computer system can: generate a query specifying the set of parameters—associated with the container image—and the set of target devices; and issue the query to the data repository that stores sets of attributes of the set of target devices.

In this example, the remote computer system can identify the first subset of target devices—on which the application container is deployable—and the second subset of target devices on which the application container is unable to deploy based on the database query.

### 7.2.1 Simulation

In one implementation, the remote computer system executes the foregoing methods and techniques: to access the set of parameters representing a task execution time threshold (e.g., two milliseconds) and a jitter value threshold (e.g., 50 microseconds); and to access the first set of attributes—of the first target device—representing the first configuration and the first state of the first target device.

In this implementation, the remote computer system: generates a virtual representation (or a “digital twin”)—of the first target device—corresponding to the first configuration and the first state; simulates execution of the container image via the virtual representation of the first target device; and accesses a set of performance characteristics responsive to execution of the container image via the virtual representation of the first device.

In response to detecting the set of performance characteristics falling within the set of parameters, the remote computer system classifies the first target device into the first subset of target devices on which the container image is deployable.

For example, the remote computer system can access the set of performance characteristics including: a set of task execution times falling below the task execution time threshold; and a set of jitter values falling below a jitter value threshold.

In this example, the system can classify the first target device into the first subset of target devices in response to detecting: each task execution time, in the set of task execution times, falling below the task execution time threshold; and each jitter value, in the set of jitter values, falling below the jitter value threshold.

Therefore, by simulating execution of the container image via the virtual representation of the first target device, the system can validate that execution of the container image conforms to performance (e.g., time criticality, determinism) constraints of the application.

### 7.3 Visualization

In one implementation, the remote computer system: generates a visualization indicating the first subset of target devices—on which the container image is deployable—and/or the second subset of target devices on which the container image is unable to deploy in Block S130; and serves the visualization to a user, such as via a user interface in Block S132.

Additionally, for each target device in the second subset of target devices, the remote computer system can generate the visualization specifying a description representing a reason(s) for validation failure.

For example, the remote computer system can generate the visualization including: a first list of target devices in the set of target devices on which the application container is deployable; and a second list of target devices in the set of target devices—and including the second target device—on which the application container is unable to deploy.

In this example, the remote computer system can generate the visualization including a description indicating that the second amount of available memory (e.g., 45 kilobytes) in the second target device falls below the threshold amount of available memory (e.g., 50 kilobytes) for the container image and defined in the set of parameters.

Therefore, by generating the visualization including the description representing the reason for validation failure, the remote computer system can: enable a system administrator to understand deficiencies of target devices in order to alter a deployment plan for the container image; and/or expose potential issues with the container image (or the application)—such as the container image exhibiting a memory footprint (e.g., a file size) that is too large for a threshold proportion of target devices under nominal conditions—to an application developer associated with the application.

Additionally or alternatively, the remote computer system can: generate a notification indicating the first subset of target devices on which the application container is deployable and/or the second subset of target devices on which the application container is unable to deploy; and serves the notification to the user.

For example, the remote computer system can: receive a request via an application programming interface to deploy a container image onto a set of target devices; detect the second subset of target devices on which the container image is unable to deploy; and return a set of error codes corresponding to the second subset of target devices via the application programming interface.

### 7.4 Deployment

In one implementation, in Block S150, the remote computer system deploys the container image onto the first subset of target devices (e.g., from the container image repository)—on which the container image is deployable—for execution.

In one example, the system deploys the container image onto the first subset of target devices in response to confirmation from the user.

In another example, the system automatically deploys the container image onto the first subset of target devices according to a policy.

### 8. Device Remediation

The method S100 includes: deriving a first set of actions that, when executed at the second device, yield a first set of projected attributes falling within the set of parameters in Block S124; identifying the first set of actions as a first candidate remediation for the second device in Block S126; and generating a visualization indicating the first candidate remediation including the first set of actions in Block S130.

Generally, in Blocks S124, S126, S130, and S132, the remote computer system can: derive a set of actions that yield a set of projected attributes—for a target device—falling within the set of parameters of the container image; and identify the set of actions as a candidate remediation for the target device. The remote computer system can then: generate a visualization specifying the remediation (e.g., the set of actions); and serve the visualization to the user.

Therefore, the remote computer system can: autonomously identify a set of actions—operable on a target device on which the container image is unable to deploy—that remediates the target device in order to enable deployment of the container image onto the target device; and report the set of actions to the user for analysis and/or confirmation.

In one implementation, the remote computer system executes the foregoing methods and techniques to classify the second target device in the second subset of target devices on which the application container is unable to deploy.

In this implementation, the remote computer system: derives a first set of actions that—when executed at the second target device—yield a first set of projected attributes falling within the set of parameters of the container image in Block S124; and identifies the first set of actions as a first candidate remediation for the second target device in Block S126.

More specifically, the remote computer system can: derive the first set of actions that—when executed at the second target device—yield attributes falling within parameters in the set of parameters of the container image; and calculate the first set of projected attributes of the second target device based on (potential execution or completion of) the first set of actions. In response to detecting the first set of projected attributes of the second target device falling within the set of parameters of the container image, the remote computer system can identify the first set of actions as the first candidate remediation for the second target device.

In another implementation, the remote computer system: generates a visualization indicating the first candidate remediation, including the first set of actions in Block S130; and serves the visualization to the user in Block S132.

For example, the system can generate the visualization indicating: a list of the first set of actions; a description of each action in the set of actions; and/or a purpose of the set of actions.

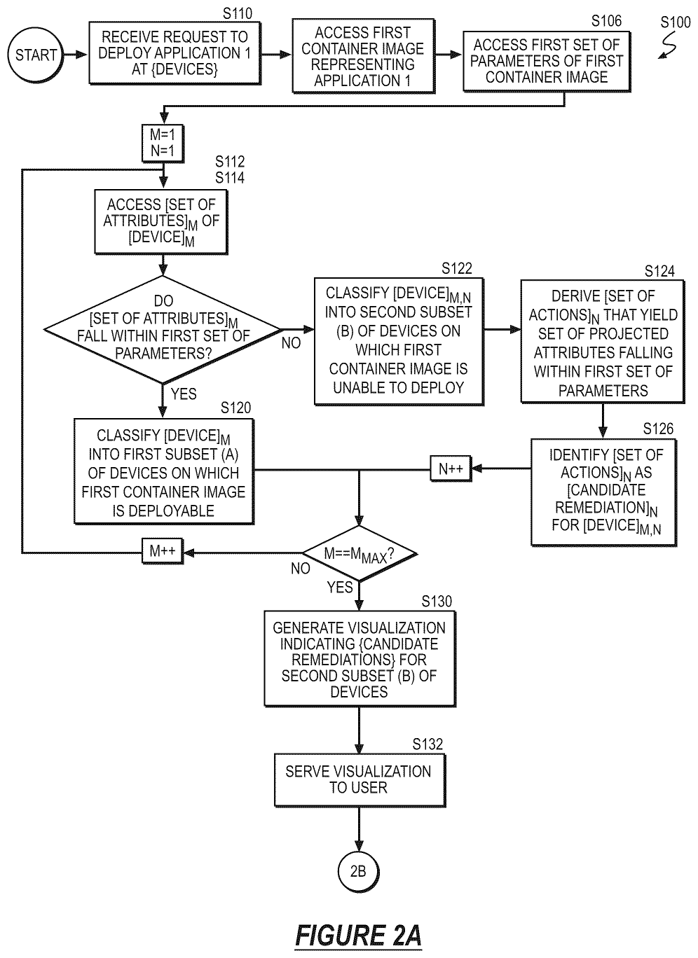

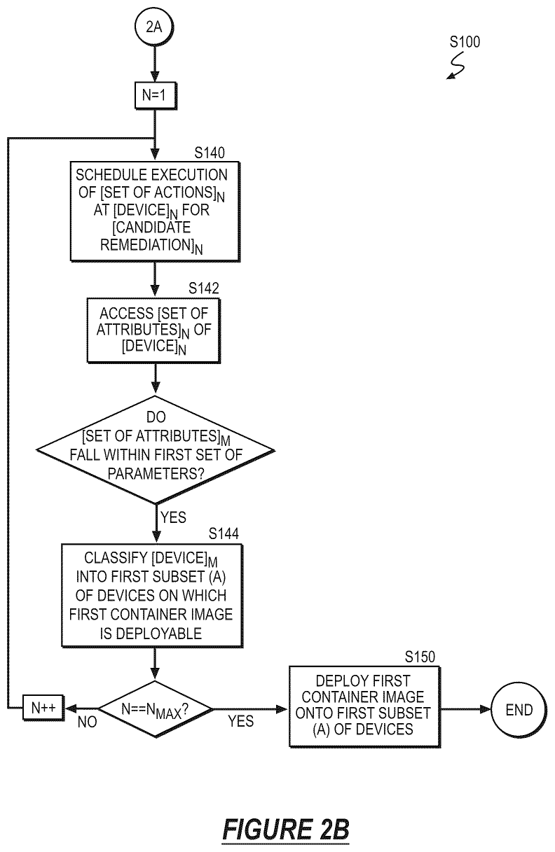

In another implementation, as shown in FIG. 2B, the remote computer system: schedules execution of the first set of actions at the second target device in response to confirmation of the first candidate remediation by the user in Block S140; accesses a third set of attributes of the second target device in response to execution of the first set of actions at the second target device in Block S142; and, in response to detecting the third set of attributes falling within the set of parameters, classifies the second device into the first subset of target devices on which the container image is deployable in Block S144.

The remote computer system can repeat the foregoing methods and techniques for each target device in the second subset of target devices on which the container image is unable to deploy: to derive a set of actions that—when executed at the target device—yield a set of projected attributes falling within the set of parameters of the container image; to identify the set of actions as a candidate remediation for the target device; to generate a visualization indicating the set of actions; and to serve the visualization to a user.

Additionally, the system can repeat the foregoing methods and techniques for each target device in the second subset of target devices: to schedule execution of the set of actions at the target device; to access a new set of attributes of the target device in response to execution of the set of actions at the target device; and, in response to detecting the third set of attributes falling within the set of parameters, classifies the target device into the first subset of target devices.

The remote computer system can then execute the foregoing methods and techniques to deploy the container image onto the first subset of target devices for execution.

### 8.1 Memory Operations

In one implementation, the remote computer system executes the foregoing methods and techniques to access the set of parameters defining constraints for deployment of the container image. For example, the container image: is characterized by a file size (e.g., 50 kilobytes); and the set of parameters represent a threshold amount of available memory based on (e.g., corresponding to) the file size for the container image.

In this implementation, the remote computer system executes the foregoing methods and techniques to access the second set of attributes—of the second target device—representing a first amount of available memory (e.g., 45 kilobytes) in the second target device.

In response to detecting the first amount of available memory falling below the threshold amount of available memory, the remote computer system executes the foregoing methods and techniques to classify the second target device into the second subset of target devices on which the container image is unable to deploy.

In this implementation, the remote computer system: derives a set of actions—representing memory operations—that yield attributes falling within parameters in the set of parameters of the container image; calculates a set of projected attributes of the second target device—representing a second amount of available memory in the second device—based on the set of actions; and identifies the set of actions as a candidate remediation for the second target device in response to detecting the second amount of available memory in the second target device exceeding the threshold amount of available memory for the container image.

For example, in response to detecting the first amount of available memory falling below the threshold amount of available memory, the remote computer system can: detect a first failure mode—in a set of failure modes—representing deficiency of available memory in the second target device for deployment of the container image; access a mapping that defines candidate actions for each failure mode in the set of failure modes; and derive the set of actions—representing memory operations (e.g., removal of temporary data)—based on the first failure mode according to the mapping.

In this example, the remote computer system can: detect a third amount of memory (e.g., 20 kilobytes) allocated to a set of temporary data (e.g., unused temporary data) based on the second set of attributes; derive the set of actions including removing (or deleting) the set of temporary data from memory in the second target device; calculate a projected amount of available memory (e.g., 65 kilobytes) in the second device based on the set of actions; and identify the set of actions as a candidate remediation for the second target device in response to detecting the projected amount of available memory in the second target device exceeding the threshold amount of available memory (e.g., 50 kilobytes) for the container image.

Therefore, by removing the set of temporary data from memory in the second target device, the remote computer system can remediate the second target device in order to enable the container image to be deployed onto the second target device, absent degradation of performance (or alteration of behavior) of the application associated with the container image.

### 8.2 Example: Execute-in-place Operating Mode

In one example, the remote computer system accesses a first set of parameters—defining constraints for deployment of a first container image characterized by a first file size (e.g., 100 kilobytes)—representing a threshold amount of available memory for the first container image based on the first file size.

In this example, the remote computer system accesses a set of attributes for a target device. The set of attributes represents: a memory capacity (e.g., 256 kilobytes) of the target device; a first amount of available memory (e.g., 45 kilobytes) in the target device; and a second amount of memory (e.g., 75 kilobytes) allocated to a second container image—representing a second application—stored (e.g., in flash storage) on the target device.

In this example, the remote computer system derives a set of actions including: pausing execution of the second container image at the target device; releasing the second amount of memory allocated to the second container image; and scheduling the second container image for execution—directly from flash storage in the target device—via an execute-in-place operating mode.

In this example, the remote computer system calculates a projected amount of available memory (e.g., 120 kilobytes) in the second device based on the set of actions; and identifies the set of actions as a candidate remediation for the target device in response to detecting the projected amount of available memory exceeding the threshold amount of available memory (e.g., 100 kilobytes) for the first container image.

More specifically, the remote computer system can: access a second set of parameters—defining constraints for deployment of the second container image—representing a task execution time threshold (e.g., two milliseconds) for the second application; calculate a projected task execution time (e.g., 1.8 milliseconds) for the second container image based on the set of actions. The remote computer system can identify the set of actions as a candidate remediation for the target device in response to: detecting the projected amount of available memory exceeding the threshold amount of available memory for the first container image; and detecting the projected task execution time for the second container image falling below the task execution time threshold (e.g., two milliseconds) for the second application.

Accordingly, the remote computer system can derive the set of actions that, when executed at the second target device, yield attributes falling within a combination of the first set of parameters of the first container image and the second set of parameters of the second container image.

Therefore, by scheduling execution of the second container image via the execute-in-place operating mode (which may degrade performance of the second application), the remote computer system can release memory allocated to the second container image in order to form sufficient available memory for deployment of the first container image at the second target device while conforming to constraints of the first application and the second application.

### 9. Container Image Remediation

The method S100 includes: based on the first container image and the first set of attributes, deriving a set of actions that yield a second set of parameters of a second container image, representing the application, for deployment onto the first device in Block S124; in response to the first set of attributes falling within the second set of parameters, identifying the set of actions as a candidate remediation for the first device in Block S126; generating a visualization in Block S130; and serving the visualization to a user in Block S132. The visualization indicates: the subset of target devices including the first device; and the candidate remediation, including the set of actions.

Generally, in Blocks S124, S126, S130, and S132, the remote computer system can: derive a set of actions for remediating the container image—into a new container image representing the application—for deployment onto a target device; to access a new set of parameters of the new container image based on the set of actions; and to identify the set of actions as a candidate remediation for the target device in response to detecting the set of attributes of the target device falling within the new set of parameters. The remote computer system can then: generate a visualization specifying the remediation (e.g., the set of actions); and serve the visualization to the user.

Therefore, the remote computer system can: autonomously identify a set of actions—operable on the container image (and/or on the target device)—that remediates the container image in order to enable deployment of the container image (or the container image representing the application) onto the target device; and report the set of actions to the user for analysis and/or confirmation.

In one implementation, the remote computer system executes the foregoing methods and techniques to access a first set of parameters defining constraints for deployment of a first container image representing a first application. For example, the first container image: includes a first application binary—representing the first application and including a first model (e.g., a machine learning model) characterized by a first size (e.g., 1000 parameters, ten kilobytes)—and a set of dependencies; and is characterized by a first file size (e.g., 50 kilobytes) based on the first application binary and the set of dependencies. In this example, the first set of parameters represents a first threshold amount of available memory based on (e.g., corresponding to) the file size for the first container image.

In this implementation, the remote computer system executes the foregoing methods and techniques: to access a first set of parameters defining constraints for deployment of a first container image representing a first application. For example, the first container image is characterized by a first file size (e.g., 50 kilobytes); and the first set of parameters represents a first threshold amount of available memory based on (e.g., corresponding to) the file size for the first container image.

In this implementation, the remote computer system executes the foregoing methods and techniques: to access a set of attributes—of a target device—representing an amount of available memory (e.g., 45 kilobytes) in the target device; and, in response to detecting the amount of available memory falling below the first threshold amount of available memory for the first container image, to classify the target device into a subset of target devices on which the first container image is unable to deploy.

In another implementation, in Block S124, the remote computer system executes similar methods and techniques described above to derive a set of actions for remediating the first container image for deployment onto the target device.

More specifically, based on the first container image and the set of attributes, the remote computer system can derive the set of actions that yield a second set of parameters of a second container image—representing the first application—for deployment onto the target device.

In one example, the remote computer system derives the set of actions including: accessing the first application binary; scanning the first application binary for a set of debug information; generating a second application binary—representing the first application—based on the first application binary and excluding the set of debug information (e.g., by removing the set of debug information from the first application binary); and generating the second container image for deployment onto the target device. The second container image: includes the second application binary and the set of dependencies; and is characterized by a second file size (e.g., 40 kilobytes) falling below the first file size.

In another example, the remote computer system derives the set of actions including: accessing a second model corresponding (e.g., similar) to the first model and characterized by a second size (e.g., 500 parameters, five kilobytes); and generating a second application binary—including the second model and excluding the first model (e.g., by replace the first model with the second model)—representing the first application; and generating the second container image for deployment onto the target device. The second container image: includes the second application binary and the set of dependencies; and is characterized by a second file size (e.g., 40 kilobytes) falling below the first file size.

In another implementation, the remote computer system: accesses (or derives) the second set of parameters of the second container image based on the set of actions; and identifies the set of actions as a candidate remediation for the target device in response to detecting the set of attributes of the target device falling within the second set of parameters of the second container image in Block S126.

For example, the remote computer system can: access the second set of parameters representing a second threshold amount of available memory (e.g., 40 kilobytes) based on the second file size; and identify the set of actions as the candidate remediation for the target device in response to detecting the first amount of available memory (e.g., 45 kilobytes) in the target device exceeding the second threshold amount of available memory for the second container image.

In this implementation, the remote computer system executes the foregoing methods and techniques to generate a visualization indicating: the subset of devices—including the target device—on which the first container image is unable to deploy; and the candidate remediation plan, including the set of actions.

Additionally, the remote computer system can execute the foregoing methods and techniques: to schedule execution of the set of actions, such as in response to confirmation of the candidate remediation by the user; to generate the second container image including the second application binary representing the first application according to the set of actions; and, in response to detecting the set of attributes of the target application falling within the second set of parameters of the second container image, classifying the target device into another subset of target devices on which a container image—representing the first application—is deployable. The remote computer system can then deploy the second container image onto devices (e.g., the target device) in this subset of target devices.

Therefore, by deriving the set of actions representing removal of debug information from the first application binary, the remote computer system can transform (or modify) the first container image into the second container image that represents the first application—potentially absent degradation of performance (or alteration of behavior) of the first application—and that reduces a memory footprint of the second container image in order to enable deployment of a containerized version of the first application onto the target device.

### 9.1 Example: Functionality Disablement

In one example, the remote computer system: accesses a first application binary representing an application including a first functionality (e.g., altitude monitoring); generates a first container image including the first application binary; derives a first set of parameters—for the first container image—including a first parameter representing presence of a sensor (e.g., a pressure sensor) for the first functionality; and accesses a set of attributes of a target device. The set of attributes represents absence of the sensor for the first functionality.

In this example, the remote computer system derives a set of actions including: generating a second application binary representing the application and excluding the first functionality (e.g., disabling the first functionality), such as by replacing calls to functions associated with the first functionality with an alternative operation (e.g., a stub, a “no-op”) and/or a default value; and generating a second container image including the second application binary.

In this example, the remote computer system: accesses a second set of parameters—excluding the first parameter representing presence of a sensor for the first functionality—of the second container image; identifies the set of actions as the candidate remediation for the target device in response to detecting the set of attributes of the target device falling within the second set of parameters of the second container image; generates a visualization indicating the candidate remediation including the set of actions; and serves the visualization to the user.

### 9.2 Example: Multiple Container Image Remediation

In another example, the remote computer system accesses a first set of parameters—defining constraints for deployment of a first container image characterized by a first file size (e.g., 50 kilobytes)—representing a first threshold amount of available memory for the first container image based on the first file size. The first container image includes: a first application binary representing a first application; and a first set of dependencies including a first library.

In this example, the remote computer system accesses a set of attributes for a target device. The set of attributes represents: a first amount of available memory (e.g., 45 kilobytes) in the target device; a second amount of memory (e.g., 75 kilobytes) allocated to a second container image stored (e.g., in flash storage) on the target device. The second container image: includes a second application binary—representing a second application—and a second set of dependencies including the first library; and is characterized by a second file size (e.g., 75 kilobytes).

In this example, the remote computer system derives a set of actions including: transforming the first set of dependencies into a third set of dependencies by removing the first library from the first set of dependencies; transforming the second set of dependencies into a fourth set of dependencies by removing the first library from the second set of dependencies; generating a third container image including the first application binary and the third set of dependencies; generating a fourth container image including the second application binary and the fourth set of dependencies; removing the second container image from the target device; loading the fourth container image onto the target device; and loading the first library onto the target device.

In this example: the third container image is characterized by a third file size (e.g., 45 kilobytes); the fourth container image is characterized by a fourth file size (e.g., 70 kilobytes); and the first library is characterized by a fifth file size (e.g., five kilobytes).

The remote computer system can then: access a third set of parameters of the third container image representing the first application; and calculate a set of projected attributes of the target device based on the set of actions. The third set of parameters represents a second threshold amount of available memory (e.g., 45 kilobytes) for the third container image based on the third file size. The set of projected attributes represents: a second amount of available memory (e.g., 45 kilobytes) in the target device; and a third amount of memory (e.g., 70 kilobytes) allocated to a fourth container image stored on the target device.

In this example, the remote computer system: identifies the set of actions as a candidate remediation for the target device and/or the first container image in response to detecting the set of projected attributes of target device falling within the second set of parameters of the second container image; generates a visualization indicating the candidate remediation including the set of actions; and serves the visualization to the user.

Therefore, rather than attempting to deploy the first container image and the second container image onto the target device with duplicate instances of the first library, the remote computer system can: recompile the first container image and the second container image as the third container image and the fourth container image that exclude the first library from these container images; and separately load the first library—which may be shared by the third container image and the fourth container image—onto the target device in order to reduce file sizes of the third container image and the fourth container image, thereby reducing a projected memory footprint of the container images on the target device and enabling deployment of these container images onto the target device.

### 9. Multiple Candidate Remediations

In one implementation, the remote computer system executes the foregoing methods and techniques: to access a first set of parameters defining constraints for deployment of a first container image; to access a set of attributes of a target device; to derive a first set of actions for remediating the target device and/or the first container image for deployment onto the target device; and to identify the first set of actions as a first candidate remediation in a set of candidate remediations for the target device.

For example, the remote computer system can: derive the first set of actions that yield a first set of projected attributes falling within the first set of parameters of the container image; and identify the first set of actions as the first candidate remediation in the set of candidate remediations for the target device. The first set of actions can be characterized by a first quantity of actions (e.g., four actions).

In this implementation, the remote computer system repeats the foregoing methods and techniques to derive an additional set of actions for remediating the target device and/or the first container image for deployment onto the target device.

In one example, the remote computer system: derives a second set of actions that yield a second set of projected attributes falling within the first set of parameters of the container image; and identifies the second set of actions as a second candidate remediation in the set of candidate remediations for the target device. The second set of actions can be characterized by a second quantity of actions (e.g., six actions).

In another example, the remote computer system derives a third set of actions—for remediating the target device and the first container image for deployment onto the target device—that yield: a third set of projected attributes of the target device based on the third set of actions; and a second set of parameters of a second container image based on the first container image and/or the set of attributes of the target device. In response to detecting the third set of projected attributes falling within the second set of parameters, the remote computer system identifies the third set of actions as a third candidate remediation in the set of candidate remediations for the target device. The third set of actions can be characterized by a third quantity of actions (e.g., twelve actions).

In another implementation, for each candidate remediation in the set of candidate remediations, the remote computer system calculates a score, in a set of scores, for the candidate remediation based on a set of actions in the candidate remediation in Block S128. The remote computer system then: selects a representative candidate remediation in the set of candidate remediations based on the set of scores; generates a visualization indicating the representative candidate remediation; and serves the visualization to the user.

In one example, the remote computer system: calculates a first score (e.g., “4”) for the first candidate remediation proportional to the first quantity of actions in the first set of actions; calculates a second score (e.g., “6”) for the second candidate remediation proportional to the second quantity of actions in the second set of actions; and calculates a third score (e.g., “12) for the third candidate remediation proportional to the third quantity of actions in the third set of actions.

In this example, the remote computer system: selects the first candidate remediation as a representative candidate remediation in response to detecting the first score falling below the second score and the third score; generates the visualization indicating the first candidate remediation including the first set of actions; and serves the visualization to the user.

In one variation, the remote computer system selects a group of (e.g., multiple) representative candidate remediations in the set of candidate remediations based on the set of scores, such as five representative candidate remediations characterized by minimum (e.g., lowest) scores among the set of candidate remediations; generates a visualization indicating the group of representative candidate remediations; and serves the visualization to the user.

### 9.1 Aggregate Scores

In one variation, for each candidate remediation in the set of candidate remediations, the remote computer system: identifies a set of actions in the candidate remediation; calculates a set of scores for the set of actions; and calculates an aggregate score—in a set of aggregate scores—for the candidate remediation based on a sum of the set of scores.

More specifically, for each action in the set of actions, the remote computer system can calculate a score—in the set of scores—for the action based on: degradation of performance of the target device, a target application, and/or other applications executing on the target device based on the action; and/or quantity of resources (e.g., compute, time, energy) for executing the action; etc.

In one example, the remote computer system: identifies a first set of actions—including a first action representing removal of (unused) temporary data from memory of the target device—in the first candidate remediation; and calculates a first set of scores for the first set of actions based on the first set of actions. The first set of scores includes a first score (e.g., “1”) for the first action representing removal of (unused) temporary data from memory of the target device. The remote computer system then calculates a first aggregate score (e.g., “4”) for the first candidate remediation corresponding to a sum of the first set of scores.

In another example, the remote computer system: identifies a second set of actions—including a second action representing scheduling a second container image in the target device for execution via the execute-in-place operating mode—in the second candidate remediation; and calculates a second set of scores for the second set of actions based on the second set of actions. The second set of scores includes a second score (e.g., “3”) for the second action representing scheduling the second container image in the target device for execution via the execute-in-place operating mode. The remote computer system then calculates a second aggregate score (e.g., “8”) for the second candidate remediation corresponding to a sum of the second set of scores.

In this variation, the remote computer system executes the foregoing methods and techniques: to select a subset of (e.g., one, multiple) representative candidate remediations in the set of candidate remediations characterized by minimum (e.g., lowest) aggregate scores in the set of aggregate scores; to generate a visualization indicating the subset of representative candidate remediations; and serves the visualization to the user.

### 10. Configuration Groups

The method S100 includes: accessing a set of parameters defining constraints for deployment of the container image in Block S106; accessing a first set of attributes of the first embedded device, the first set of attributes representing a first configuration of the first embedded device in Block S112; in response to correspondence between the first set of attributes and a first combination of attributes for a first configuration group, assigning the first embedded device to the first configuration group in Block S116; and, in response to the first combination of attributes falling outside of the set of parameters, classifying devices in the first configuration group into a subset of embedded devices on which the container image is unable to deploy in Block S122.

The method S100 also includes: deriving a set of actions that, when executed at the first embedded device, yield a set of projected attributes falling within the set of parameters in Block S124; and identifying the set of actions as a candidate remediation for embedded devices in the first configuration group in Block S126.

Generally, in Blocks S106, S110, S112, S116, S122, S124, and S126, the remote computer system can: access a request to deploy a container image onto a set of target devices; access a set of parameters of the container image; and access a set of combinations of attributes—for a set of configuration groups—representing configurations characteristic of target devices in these configuration groups. For each target device in the set of target devices, the remote computer system can: access a set of attributes characterizing the target device; classify the target device into a configuration group in the set of configuration groups based on correspondence between the set of attributes of the target device and a combination of attributes for the configuration group; and, in response to detecting the set of attributes and/or the combination of attributes falling outside of the set of parameters of the container image, classify the configuration group (e.g., target devices in the configuration group) into the second subset of target devices on which the container image is unable to deploy.

Then, for each configuration group classified into the second subset of target devices on which the container image is unable to deploy, the remote computer system can derive a set of actions—for remediating the target devices in the configuration group and/or the container image for deployment onto these target devices—that yield a set of projected attributes falling within the set of parameters of the container image (or a second set of parameters of a second container image based on the container image) to enable deployment of the container image (or the second container image) onto these target devices; and identify the set of actions as a candidate remediation for target devices in the configuration group.

Accordingly, the remote computer system can: group many (e.g., 100, 1000) target devices exhibiting identical configurations into a configuration group; detect a potential deployment failure of a container image for target devices in the configuration group; derive a set of actions, for target devices in the configuration group, that enable deployment of the container image onto these target devices; validate the set of actions for a representative target device in the configuration group; and, in response to successful validation of the set of actions for the representative target device, designate the set of actions as a candidate remediation for all target devices in the configuration group.

Therefore, rather than separately deriving and validating remediation actions for each target device on a per-device basis, the remote computer system can: identify a configuration that is shared (or common) across a group of target devices; derive a set of actions—specific to this configuration—that resolve the potential deployment failure of the container image to this group of target devices; and validate the set of actions for a representative target device in the group, thereby enabling one instance of derivation and validation of the set of actions to scale across many (e.g., 100, 1000) target devices exhibiting this configuration.

### 10.1 First Configuration Group

In one implementation, the remote computer system executes the foregoing methods and techniques: to receive a request to deploy a container image onto a set of target devices (e.g., embedded devices, sensors, cameras, smartphones) in Block S110; and to access a set of parameters defining constraints for deployment of the container image in Block S106. The set of target devices includes: a first target device; a second target device; and a third target device.

In this implementation, the remote computer system accesses a set of combinations of attributes for a set of configuration groups. Each combination of attributes—in the set of combinations of attributes—represents (distinct) configurations (e.g., hardware configurations, software configurations) characteristic of devices in a configuration group in the set of configuration groups.

For example, the remote computer system accesses the set of combinations of attributes including a first combination of attributes—for a first configuration group in the set of configuration groups—representing: a first instruction set architecture; a first processor type; and/or a first set of container images including a second container image.

In this example, the remote computer system accesses the set of combinations of attributes including a second combination of attributes—for a second configuration group in the set of configuration groups—representing: a second instruction set architecture different from the first instruction set architecture; a second processor type different from the first processor type; and/or the first set container images including the second container image.

Additionally, the remote computer system can access the set of combinations of attributes including a third combination of attributes—for a third configuration group in the set of configuration groups—representing: the first instruction set architecture; the first processor type; and/or a second set of container images excluding the second container image.

In another implementation, the remote computer system accesses a first set of attributes of the first target device in Block S112. The first set of attributes represents a first configuration of the first target device. For example, the set of attributes can represent: the first instruction set architecture; the first processor type; and/or the first set of container images including a second container image; etc.

In this implementation, the remote computer system detects correspondence between the first set of attributes and the first combination of attributes—in the set of combinations of attributes—for the first configuration group. In response to detecting correspondence between the first set of attributes and the first combination of attributes for the first configuration group, the remote computer system assigns the first target device to the first configuration group in Block S116.

### 10.1.1 Additional Target Devices

The remote computer system repeats the foregoing methods and techniques to classify other target devices in the set of target devices into the first configuration group.

For example, the remote computer system accesses a second set of attributes of a second target device in the set of target devices. The second set of attributes represents: the first instruction set architecture; the first processor type; and/or the first set of container images including a second container image; etc.

In this example, the remote computer system detects correspondence between the second set of attributes and the first combination of attributes for the first configuration group. In response to detecting correspondence between the second set of attributes and the first combination of attributes for the first configuration group, the remote computer system assigns the second target device to the first configuration group in Block S116.

### 10.1.2 Candidate Remediation for First Candidate Group

In another implementation, in response to detecting the first combination of attributes falling outside of the set of parameters, the remote computer system classifies devices in the first configuration group—including the first target device and the second target device—into the second subset of target devices on which the container image is unable to deploy in Block S22.

In another implementation, the remote computer system executes the foregoing methods and techniques to derive a first set of actions that, when executed at a target device in the first configuration group, yields attributes falling within the set of parameters.

Additionally or alternatively, the remote computer system executes the foregoing methods and techniques to derive a first set of actions for remediating the container image—into a new container image representing the application—for deployment onto target devices in the first configuration group in Block S124.

In another implementation, the remote computer system executes the foregoing methods and techniques to: calculate a first set of projected attributes of the first target device based on the first set of actions; and, in response to detecting of the first set of projected attributes falling within the set of parameters of the container image (or a second set of parameters of the new container image), identify the first set of actions as a candidate remediation for target devices in the first configuration group in Block S126.

### 10.2 Second Configuration Group

In another implementation, the remote computer system repeats the foregoing methods and techniques: to classify other target devices in the set of target devices into a configuration group in the set of configuration groups.

For example, the remote computer system accesses a third set of attributes of a third target device in the set of target devices. The third set of attributes represents: the second instruction set architecture, different from the first instruction set architecture; the second processor type, different from the first processor type; and/or the first set of container images including the second container image.

In this example, the remote computer system detects correspondence between the third set of attributes and the second combination of attributes for the second configuration group. In response to detecting correspondence between the third set of attributes and the second combination of attributes for the second configuration group, the remote computer system assigns the third target device to the second configuration group in Block S116.

In response to detecting the second combination of attributes falling outside of the set of parameters, the remote computer system classifies devices in the second configuration group—including the third target device—into the second subset of target devices on which the container image is unable to deploy in Block S122.

In this example, the remote computer system: derives a second set of actions that remediates target devices in the second configuration group and/or the container image for deployment onto these target devices in the second configuration group in Block S124.

More specifically, the remote computer system can: derive the second set of actions, different from the first set of actions and executable at target devices in the second configuration group, that yield a second set of projected attributes falling within the set of parameters of the container image; and identify the second set of actions as a candidate remediation for target devices in the second configuration group in Block S126.

The remote computer system repeats the foregoing methods and techniques for each configuration group in the set of configuration groups: to derive a set of actions that remediate target devices in the configuration group; to calculate a set of projected attributes of a target device in the configuration group based on the set of actions; and, in response to detecting the set of projected attributes falling within the set of parameters of the container image, to identify the set of actions as a candidate remediation for target devices in the configuration group.

### 10.3 Visualization

In another implementation, the remote computer system executes the foregoing methods and techniques: to generate a visualization indicating the second subset of target devices on which the container image is unable to deploy in Block S130; and to serve the visualization to the user in Block S132.

More specifically, for each configuration group in the second subset of target devices, the remote computer system generates the visualization indicating: target devices in the configuration group; and a candidate remediation for target devices in the configuration group.

For example, the remote computer system can generate the visualization indicating: the first configuration group including the first target device and the second target device; and the first candidate remediation including the first set of actions.

In this example, the remote computer system can generate the visualization indicating: the second configuration group including the third target device; and the second candidate remediation including the second set of actions.

### 10.4 Remediation & Deployment

In another implementation, for each configuration group in the second subset of target devices, the remote computer system executes the foregoing methods and techniques: to schedule execution of a set of actions—in a candidate remediation for target devices in the configuration group—at each target device in the configuration group in Block S140, such as in response to confirmation of the candidate remediation by the user; and to deploy the container image onto these target devices in the configuration group for execution in Block S150.

### 11. Disclaimers

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
receiving a request to deploy a container image onto a set of devices comprising a first device and a second device, the container image comprising:
an application binary representing an application; and
a set of dependencies for executing the application binary;
accessing a set of parameters defining constraints for deployment of the container image;
accessing a first set of attributes of the first device;
accessing a second set of attributes of the second device;
in response to the first set of attributes falling within the set of parameters, classifying the first device into a first subset of devices on which the container image is deployable;
in response to the second set of attributes falling outside of the set of parameters, classifying the second device into a second subset of devices on which the container image is unable to deploy;
deriving a first set of actions that, when executed at the second device, yield a first set of projected attributes falling within the set of parameters;
identifying the first set of actions as a first candidate remediation for the second device;
generating a visualization indicating:
the second subset of devices comprising the second device; and
the first candidate remediation comprising the first set of actions; and
serving the visualization to a user.

2. The method of claim 1:
wherein accessing the second set of attributes comprises:
accessing the second set of attributes representing:
a first instruction set architecture; and
a first processor type; and
in response to correspondence between the second set of attributes and a first combination of attributes for a first configuration group, assigning the second device to the first configuration group; and
wherein classifying the second device into the second subset of devices comprises, in response to the first combination of attributes falling outside of the set of parameters, classifying devices in the first configuration group into the second subset of devices.

3. The method of claim 2:
further comprising:
accessing a third set of attributes of a third device in the set of devices; and
in response to correspondence between the third set of attributes and the first combination of attributes for the first configuration group, assigning the third device to the first configuration group;
wherein classifying devices in the first configuration group into the second subset of devices comprises classifying the third device into the second subset of devices;
wherein deriving the first set of actions comprises deriving the first set of actions executable at devices in the first configuration group;
wherein identifying the first set of actions as the first candidate remediation comprises identifying the first set of actions as the first candidate remediation for devices in the first configuration group; and
wherein generating the visualization comprises generating the visualization indicating the second subset of devices comprising:
the second device; and
the third device.

4. The method of claim 2:
wherein identifying the first set of actions as the first candidate remediation comprises identifying the first set of actions as the first candidate remediation for reclassifying devices in the first configuration group into the first subset of devices on which the container image is deployable; and
further comprising:
scheduling execution of the first set of actions at each device in the first configuration group; and
deploying the container image onto devices in the first configuration group for execution.

5. The method of claim 2:
further comprising:
accessing a third set of attributes of a third device in the set of devices, the third set of attributes representing:
a second instruction set architecture different from the first instruction set architecture; and
a second processor type different from the first processor type;
in response to correspondence between the third set of attributes and a second combination of attributes for the second configuration group, assigning the third device to a second configuration group;
in response to the second combination of attributes falling outside of the set of parameters, classifying devices in the second configuration group into the second subset of devices;
deriving a second set of actions, different from the first set of actions and executable at devices in the second configuration group, that yield a second set of projected attributes falling within the set of parameters of the container image; and
identifying the second set of actions as a second candidate remediation for reclassifying devices in the second configuration group into the first subset of devices on which the container image is deployable; and
wherein generating the visualization comprises generating the visualization indicating the second candidate remediation comprising the second set of actions for devices in the second configuration group.

6. The method of claim 1:
wherein accessing the set of parameters comprises accessing the set of parameters defining constraints for deployment of the container image characterized by a first file size, the set of parameters representing a threshold amount of available memory based on the first file size;
wherein accessing the second set of attributes comprises accessing the second set of attributes representing a first amount of available memory in the second device;
wherein classifying the second device into the second subset of devices comprises, in response to the first amount of available memory falling below the threshold amount of available memory, classifying the second device into the second subset of devices on which the container image is unable to deploy;
wherein deriving the first set of actions comprises deriving the first set of actions representing memory operations that yield the first set of projected attributes representing a second amount of available memory in the second device; and
wherein identifying the first set of actions as the first candidate remediation comprises, in response to the second amount of available memory exceeding the threshold amount of available memory, identifying the first set of actions as the first candidate remediation for the second device.

7. The method of claim 6, wherein deriving the first set of actions comprises:
in response to the first amount of available memory falling below the threshold amount of available memory, detecting a first failure mode in a set of failure modes representing deficiency of available memory in the second device for deployment of the container image;
accessing a mapping that defines candidate actions for the first failure mode; and
deriving the set of actions based on the first failure mode according to the mapping.

8. The method of claim 6:
wherein accessing the second set of attributes comprises accessing the second set of attributes representing a third amount of memory allocated to a second container image representing a second application and stored on the second device; and
wherein deriving the first set of actions comprises deriving the first set of actions comprising:
releasing the third amount of memory from the second container image; and
scheduling the second container image for execution via an execute-in-place operating mode.

9. The method of claim 1:
wherein accessing the first set of attributes comprises accessing the first set of attributes representing:
a first configuration of the first device; and
a first state of the first device; and
wherein classifying the first device into the first subset of devices comprises:
generating a virtual representation, of the first device, corresponding to the first configuration and the first state of the first device;
simulating execution of the container image via the virtual representation of the first device;
accessing a set of performance characteristics responsive to execution of the container image via the virtual representation of the first device; and
in response to the set of performance characteristics falling within the set of parameters, classifying the first device into the first subset of devices.

10. The method of claim 9:
wherein accessing the set of parameters comprises accessing the set of parameters representing:
a task execution time threshold; and
a jitter value threshold;
wherein accessing the set of performance characteristics comprises accessing the of performance characteristics comprising:
a set of task execution times; and
a set of jitter values; and
wherein classifying the first device into the first subset of devices comprises classifying the first device into the first subset of devices in response to detecting:
each task execution time, in the set of task execution times, falling below the task execution time threshold; and
each jitter value, in the set of jitter values, falling below the jitter value threshold.

11. The method of claim 1:
wherein accessing the set of parameters comprises accessing the set of parameters representing presence of a pressure sensor;
wherein accessing the first set of attributes comprises accessing the first set of attributes representing presence of a first pressure sensor in the first device; and
wherein classifying the first device into the first subset of devices comprises, in response to presence of the first pressure sensor in the first device, classifying the first device into the first subset of devices on which the container image is deployable.

12. The method of claim 1, further comprising:
in response to confirmation of the first candidate remediation by the user, scheduling execution of the first set of actions at the second device;
in response to execution of the first set of actions at the second device, accessing a third set of attributes of the second device;
in response to the third set of attributes falling within the set of parameters, classifying the second device into the first subset of devices on which the container image is deployable; and
deploying the container image onto the first subset of devices for execution.

13. The method of claim 1:
further comprising:
deriving a second set of actions that, when executed at the second device, yield a second set of projected attributes falling within the set of parameters;
identifying the first set of actions as a second candidate remediation for the second device;
calculating a first score for the first candidate remediation proportional to a first quantity of actions in the first set of actions; and
calculating a second score for the second candidate remediation proportional to a second quantity of actions in the second set of actions; and
wherein generating the visualization comprises generating the visualization indicating the first candidate remediation in response to the first score falling below the second score.

14. The method of claim 1:
wherein identifying the first set of actions as the first candidate remediation comprises identifying the first set of actions as the first candidate remediation in a set of candidate remediations for the second device, each action in the first set of actions characterized by a score;
further comprising:
calculating a first set of scores for the first set of actions; and
calculating a first aggregate score, in a set of aggregate scores, for the first candidate remediation based on a sum of the first set of scores; and
wherein generating the visualization comprises generating the visualization indicating the first candidate remediation in response to identifying the first aggregate score as a minimum aggregate score in the set of aggregate scores.

15. The method of claim 1:
wherein accessing the set of parameters comprises deriving the set of parameters based on:
the application binary;
the set of dependencies; and
a set of performance constraints for the application; and
further comprising:
accessing the application binary and the set of dependencies;
generating the container image comprising the application binary and the set of dependencies;
storing the container image in a container image repository; and
in response to receiving the request, deploying the container image from the container image repository onto the first subset of devices for execution.

16. A method comprising:
accessing a first application binary representing an application;
generating a first container image comprising the first application binary and a set of dependencies for executing the first application binary;
accessing a first set of parameters defining constraints for deployment of the first container image based on the first application binary and the set of dependencies;
receiving a request to deploy the first container image onto a set of devices comprising a first device;
accessing a first set of attributes of the first device;
in response to the first set of attributes falling outside of the first set of parameters, classifying the first device into a subset of devices on which the first container image is unable to deploy;
based on the first container image and the first set of attributes, deriving a set of actions that yield a second set of parameters of a second container image, representing the application, for deployment onto the first device;
in response to the first set of attributes falling within the second set of parameters, identifying the set of actions as a candidate remediation for the first device;
generating a visualization indicating:
the subset of devices comprising the first device; and
the candidate remediation comprising the set of actions; and
serving the visualization to a user.

17. The method of claim 16:
wherein accessing the first application binary comprises accessing the first application binary representing the application comprising a first functionality;
wherein accessing the first set of parameters comprises accessing the first set of parameters comprising a first parameter representing presence of a sensor for the first functionality;
wherein accessing the first set of attributes comprises accessing the first set of attributes representing absence of the sensor for the first functionality; and
wherein deriving the set of actions comprises deriving the set of actions comprising:
generating a second application binary representing the application excluding the first functionality;
generating the second container image for deployment onto the first device, the second container image comprising:
the second application binary; and
the set of dependencies; and
deriving the second set of parameters, excluding the first parameter.

18. The method of claim 16:
wherein generating the first container image comprises generating the first container image characterized by a first file size;
wherein accessing the first set of parameters comprises accessing the first set of parameters representing a first threshold amount of available memory based on the first file size;
wherein accessing the first set of attributes comprises accessing the first set of attributes representing a first amount of available memory;
wherein classifying the first device into the subset of devices comprises, in response to the first amount of available memory falling below the first threshold amount of available memory, classifying the first device into the subset of devices;
wherein deriving the set of actions comprises deriving the set of actions comprising:
scanning the first application binary for a set of debug information;
generating a second application binary based on the first application binary and excluding the set of debug information;
generating the second container image for deployment onto the first device, the second container image:
comprising the second application binary and the set of dependencies; and
characterized by a second file size falling below the first file size; and
deriving the second set of parameters representing a second threshold amount of available memory based on the second file size; and
wherein identifying the set of actions as the candidate remediation comprises, in response to the first amount of available memory exceeding the second threshold amount of available memory, identifying the set of actions as the candidate remediation for the first device.

19. A method comprising:
receiving a request to deploy a container image onto a set of embedded devices comprising a first embedded device, the container image comprising:
an application binary representing an application; and
a set of dependencies for executing the application binary;
accessing a set of parameters defining constraints for deployment of the container image;
accessing a first set of attributes of the first embedded device, the first set of attributes representing a first configuration of the first embedded device;
in response to correspondence between the first set of attributes and a first combination of attributes for a first configuration group, assigning the first embedded device to the first configuration group;
in response to the first combination of attributes falling outside of the set of parameters, classifying devices in the first configuration group into a subset of embedded devices on which the container image is unable to deploy;
deriving a set of actions that, when executed at the first embedded device, yield a set of projected attributes falling within the set of parameters; and
identifying the set of actions as a candidate remediation for embedded devices in the first configuration group.

20. The method of claim 19, further comprising:
scheduling execution of the set of actions at each embedded device in the first configuration group; and
in response to execution of the set of actions at embedded devices in the first configuration group, deploying the container image onto embedded devices in the first configuration group for execution.
